(19) United States
(12) Patent Application Publication
(10) Pub. No.: US 2005/0119977 A1
(43) Pub. Date: Jun. 2, 2005

(54) Management of digital content licenses

(75) Inventor: Nathan F. Raciborski, Phoenix, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Limelight Networks, LLC, Phoenix, AZ (US)

(21) Appl. No.: 10/936,446

(22) Filed: Sep. 7, 2004

Related U.S. Application Data
(60) Provisional application No. 60/500,530, filed on Sep. 5, 2003.

(51) Int. Cl. G06F 17/60; H04K 1/00

(52) U.S. Cl. 705/59

(57) ABSTRACT

According to the invention, a method for management of pieces of content and content licenses is disclosed. In one step, a content license is sold for the first piece of content to a user. The content license is stored. A first piece of content is provided in a first form. The content license is analyzed. An offer for a second piece of content in a second form is determined, where the offer is affected by the content license and the first form is different from the second form. The second piece of content is sold to the user according to the offer. The second piece is sold in a second transaction different from a first transaction where the first piece is sold. At least one of the first and second piece of content is in digital form.

This application claims the benefit of and is a non-provisional of U.S. Application Ser. No. 60/500,530 filed on Sep. 5, 2003, which is incorporated by reference in its entirety.

This application is related to U.S. patent application Ser. No. ______, filed on the same date as the present application, entitled “AUTHENTICATION OF CONTENT DOWNLOAD” (temporarily referenced by Attorney Docket No. 40152-000410US), which is incorporated by reference in its entirety.

### BACKGROUND OF THE DISCLOSURE

This disclosure relates in general to managing content licenses and, more specifically, but not by way of limitation, to controlling use of digital content under a copyright license.

The copyright license for content is currently tied to the delivery mechanism. For example, if one buys a song on a cassette tape that song must be purchased again to get a version on a compact disc. Even for downloaded music, a song downloaded in a particular bitrate or format must be purchased again if a different bitrate or format is desired. For example, a song may be originally purchased with a 128K bitrate which could be appropriate for a solid-state based music player. Later, a 256K bitrate version may be desired for use on a hard drive based music player. The user is forced to pay for the higher bitrate version if the additional quality is desired as the digital rights management is tied to the file (i.e., delivery mechanism).

Some download services have digital rights management (DRM) that controls use of the delivered content file. The DRM may allow a certain number of copies or allow changing the format. For example, a user may download a 160K bitrate song in Advanced Audio Coding (AAC) format that can be loaded onto a predefined number of music players and burned to a compact disk a predefined number of times. The quality of music on the compact disk is limited because it can be no better than that afforded by a highly-compressed 160K bitrate AAC source format. To get a higher quality compact disk, the song would need to be purchased on a compact disk or in a higher-quality file.

A personal video recorder (PVR) is a device that records video programming at a user's home. The video can be time-shifted for viewing at a time later than when it was originally broadcast. One PVR manufacturer has a feature that allows a recorded program to be sent to a predetermined number of other PVRs. Those other PVRs can play the program with full control of playback.

Music and video distributors take advantage of changes in format of their content. With the advent of a new media format, many users will repurchase their content in that new format. The distributors and artists can get paid twice for the same copyright. For example, when CDs were released, many replaced their vinyl records and cassettes to take advantage of the new format. This phenomenon occurs even though the copyright license and fair use principals would allow re-recording the vinyl records and cassettes on a CD.

### BRIEF DESCRIPTION OF THE DRAWINGS

The present disclosure is described in conjunction with the appended figures:

FIGS. 1A, 1B, 1C, 1D, and 1E are block diagrams of embodiments of a content management system;

FIGS. 2A, 2B and 2C are data structures of embodiments of a download manager file;

FIGS. 3A, 3B and 3C are data structures of embodiments of a digital media file;

FIGS. 4A, 4B and 4C are flow diagrams of embodiments of a process for ordering digital content;

FIG. 5 is a flow diagram of an embodiment of a process for licensing a digital content portion; and

FIG. 6 is a chart of an embodiment of media relationships for a small portion of a content catalog.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In one embodiment of the invention, the digital rights management (DRM) is tied to the piece of content and not the delivery mechanism. For example, a user may download an MP3 version of a song, but later get a WMA version of the song for free. A database is maintained either local or remote to the user that records all license rights to content. The user can get versions of the content in different format, bitrate, and/or media at a later date. The database may have an entry for each user and/or an entry for each instance of the content sold. In some cases, the original version may be destroyed before providing the new version to effect a trade.

The license rights may be tied to an individual, a family or a group of persons. The license rights may expire or be curtailed over time. For example, the user may be able to get a song in any format for five years or pay an ever increasing percentage of the cost of the new format over time. In the first year, exchanges may be free, but in the third year, a fee of 20% of the cost of the song in the new format may be required and so on.

The license right may entitle the user to a number of instances of the content. For example, the user may be able to simultaneously have a song on their MP3 player that was downloaded with a particular quality and on up to three compact discs that was downloaded at a higher quality than the MP3 version. When a higher bitrate MP3 format version of the same song is later purchased, that could require destroying or disabling playback of the lower bitrate version previously downloaded. The higher bitrate MP3 may require additional payment or could have been contemplated in the original purchase such that an addition fee is not required.

The right to content may extend across different types of content. Rights between, print pictures or text; electronic pictures, text, music, sound, or video; or performance version may be exchangeable with or without additional consideration. Any type of content that can be bought or sold is potentially included, such as video content, audio content, music content, still picture content, theatrical content, live performance content, aroma content, art content, printed text content, e-book content, audio book content, etc. For example, the right to have a print book may allow credit or exchange for the e-book version, the audio book version, the live theater version, or the movie version. Buyers of the book may be able to exchange their book for a credit against the movie version. The credit could be complete credit or fractional credit. In another example, a user may attend a movie at a theatre. A code on the ticket stub could be entered into the system of a content vendor to allow purchase of a DVD or MP4 version at a discount.

In some cases, the delivery media is used to demonstrate a right to use a version of the content. Possession of the delivery media (e.g., cassette tape, vinyl record, compact disk, DVD, performance ticket stub, DRM controlled file, etc.) may be used to show entitlement to the content. In some embodiments, the delivery media may include a unique code to identify a particular copy of the content. Entitlements could be tied to that unique code such that information on the user is not required.

In other cases, the entitlement to content is tied to a user or group of users. The entitlements are stored in a database separate from the content media. The database is maintained by a content provider in one embodiment, but could be linked to other parties such that many parties could verify the entitlement to the user. Some embodiments may include a number of databases that are linked in some manner so a query to any database could result in the entitlement rights of a particular user to a piece of content.

To receive credit, the subsequent version of the content may require receipt of the old version of the content or its destruction. For example, return of a cassette tape version of an album would result in a 50% credit against the video music DVD version. Where the old version is retained, the right to both versions may be merged to prevent separate sale. Furthering the preceding example, if the cassette could be retained, a purchaser of the cassette would not receive any right to use the cassette and would not receive any credit toward subsequent versions. However, a purchaser of the DVD version could receive credit.

In some cases, returning the old version can be performed for electronic files that don't have a physical media. Digital rights management (DRM) allows protecting content regardless of storage media. Use of a video may be restricted by the DRM to licensed use such that copying is prohibited. When the video is turned in for credit, the DRM could prevent further use of any retained file or could be transported with the returned file. For example, a video content file could be returned for a credit. The returned video content file could be resold to others on the same license terms enforced by the DRM. Of course, the license terms could prevent sale by the original purchaser. This term could be enforced by the DRM.

Some embodiments may have entitlements stored at the content owner, licensor or their representative. The database could be queried to determine if a user or group of users was entitled to upgrade or exchange a piece of content. The user can query the database when upgrading or exchanging content or when such a transaction is contemplated. Any credit or destruction rules are made available to the user and/or merchant. Destruction may require return of the prior version or the merchant to confirm its destruction.

In some embodiments, the DRM for content players could be updated to prevent further playback of prior versions. The content player could query an entitlements database to determine if playback is authorized. Where playback is no longer allowed, the DRM would prevent it. The content player may automatically substitute playback for the new version of the content.

The rights issued to purchasers of content could flexibly incorporate a license to many other uses of the content. For example, purchase of a DVD video could allow playback of the embedded music soundtrack. Further, the purchase could allow small video clips and/or still snapshots to be extracted from the video for certain uses. In another example, purchase of the pay-per-view right to watch a boxing match may allow recordation on a personal video recorder (PVR) for time-shifted viewing and extraction of a clip of the knock-out punch for later playback on the user's computer. The clips could be extracted from the DVD or made available for download to entitled users. Where the user is entitled to a non-commercial license to the DVD, the subsequent versions could also be so limited. In other cases, the scope of the license could change. For example, the DVD video could have a trailer or other commercials. Any user could automatically get entitlement to distribute the extracted trailer or commercial.

Some embodiments could limit transportability of content entitlements in various ways. In one example, exchanges and upgrades are only allowed with a particular content provider. If the user tried to get a related piece of content from another content provider, no credit or reduced credit would be given. The credit could be reduced by a fee to transport the entitlement to the new content provider. For example, the user may be given free ability to a song in any format purchased from a particular Internet vendor. That entitlement would be in the database for that Internet vendor. Other Internet vendors may completely ignore that entitlement or give some reduced credit for the prior purchase.

In one embodiment, a user may get related rights at other content providers. A purchase could be made at a first store that would entitle discounts on related product at a second store. For example, purchase of a music CD at a bricks and mortar store could entitle the user to get a compressed electronic version (e.g., MP3, WMA, etc.) for a discount of 1%-99% from a second store. The second store may or may not be affiliated with the first store.

Related products that allow license carry-over rights could be related in any number of ways. The license for the first purchased content or the second purchased content could define the extensibility. Examples include same artist, label and/or genre; same author, performer, and/or sports team or organization; and/or same theatrical venue, performance troop, etc. The licensors of the related content can define their relationship in any way. That relationship can be delivered at the first content delivery or any later delivery that is related. For example, a user may have purchased an 8-track of an artist thirty years ago. Today, the copyright holder may offer a CD version that is the same or similar for a 80% discount if the 8-track version is returned.

The user may be given various prices when content is purchased according to a spectra of rights that might be granted. The cheapest price could be for the content in a single format. An enhanced price could allow replacement formats, bitrates, and media for a period of time, an unlimited time, a number of uses, etc. Other prices could correspond to related content such as credit toward related books, songs, performances, videos, etc. For example, download of a song may be $1 and entitlement to the song in any format for five years could be $1.10. Some embodiments may sell the ability to upgrade or change content as a service. For example, for a monthly charge subscribers can freely exchange their rights to related content while paying nothing or an increment of the cost difference.

Instead of using a database, some electronic content could include license rights in metadata. The extent of the rights granted to the user could be embedded in XML. Subsequent purchases of related content could inspect the extent of the rights to determine if any discount or extension is available to the related content. The rights information could be protected in the content file metadata.

Some embodiments may allow sale of the entitlement to content to others. The credit could be used as a store credit or be distributed in cash. For example, by destroying or preventing use of a piece of content could result in a 50% credit of the original purchase price. The percentage credit could be reduced over time as the value of the content piece decreases. For example, return of the right to further view a pay-per-view boxing match a day later could result in a 5% credit of the purchase price.

Some content purchases may allow the purchaser to sale the rights they acquired to others. For example, a compact disk and the right to the music in other formats may be sold to another user. That user could de-register the entitlement and register that entitlement to the user. Where the media has a unique identifier, mere possession could affect that transfer. Databases could be used to electronically transfer the right. In some cases, a license transfer fee could be charged when one user sells rights to another.

Users could batch upgrade their content in some embodiments. The user could specify that a grouping of content be upgrade at one time. For example, the user may prefer to have his or her music collection in WMA format rather than MP3. The user could specify that all content available in WMA format be exchanged by their content player or other software. Access to the earlier format may or may not be disabled depending on the entitlements of the user. The content player would check the rights for each piece of content and replace with a version in the other format.

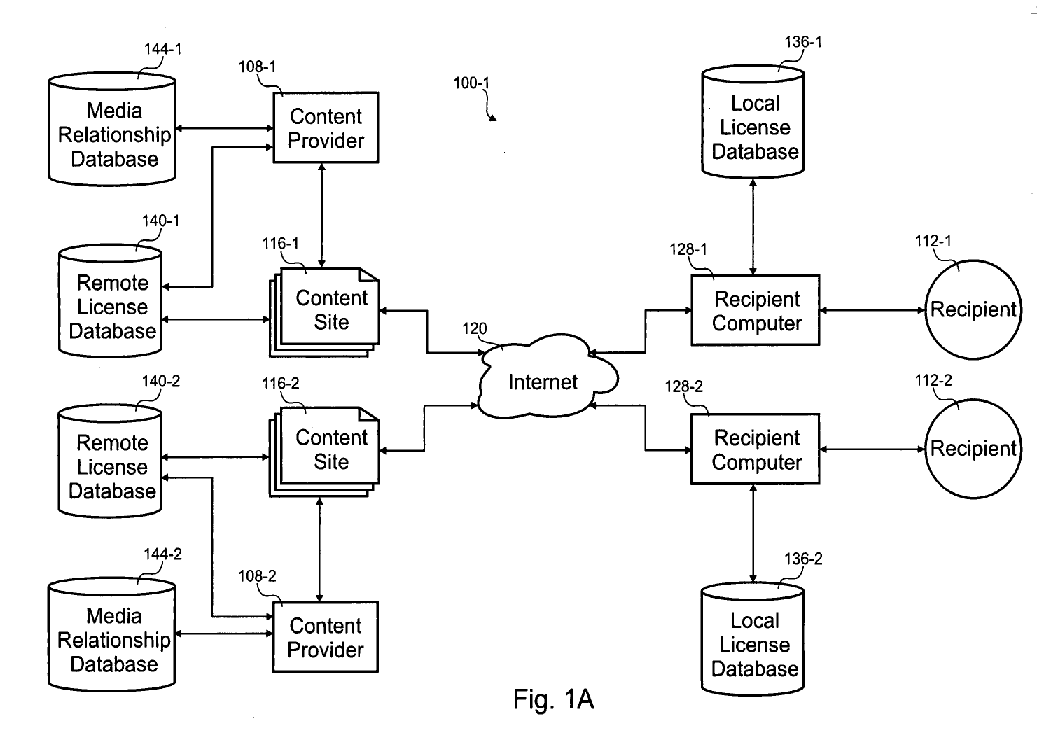

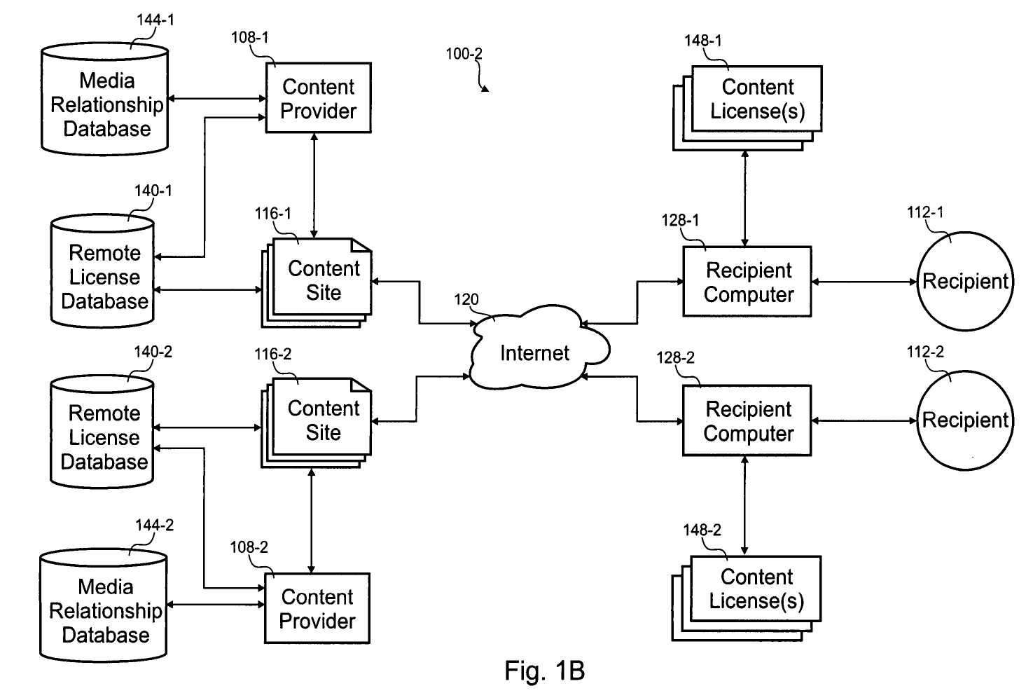

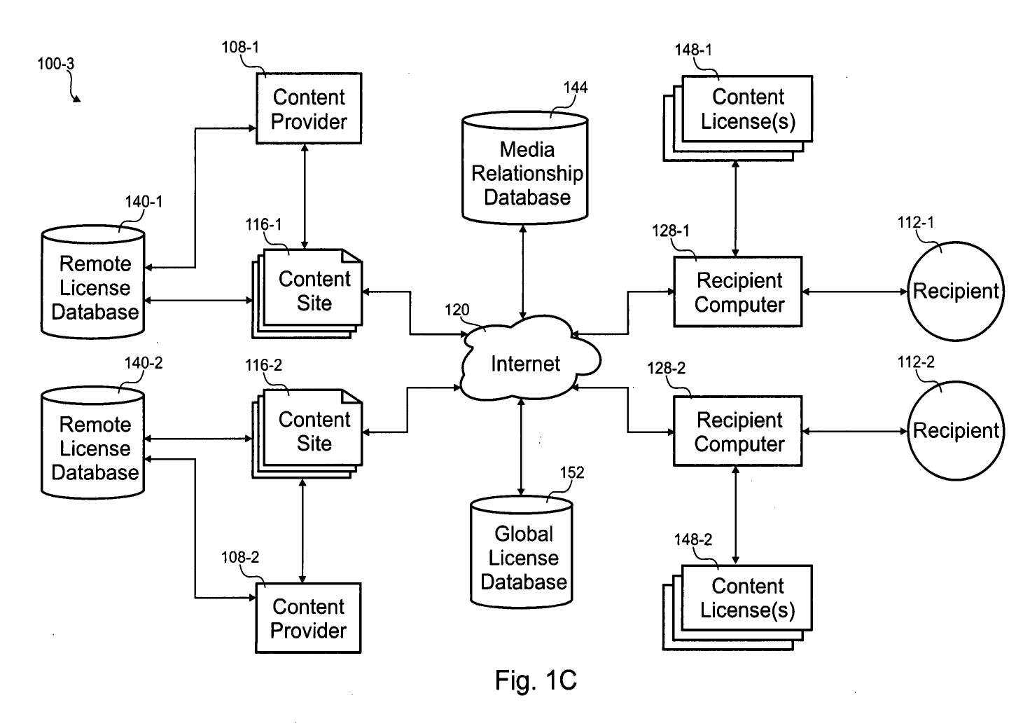

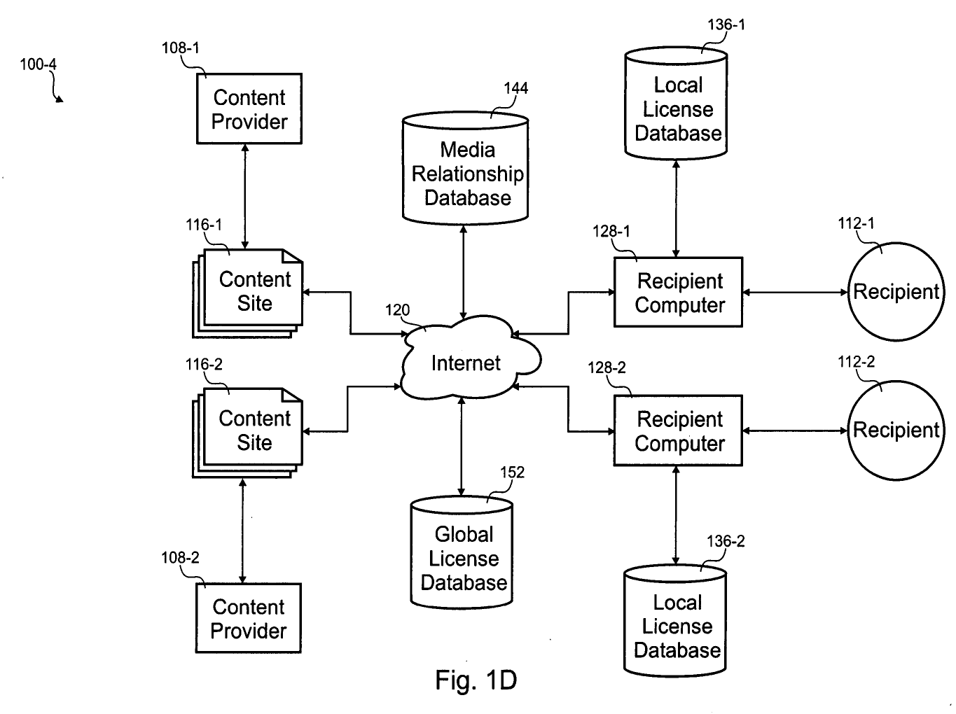

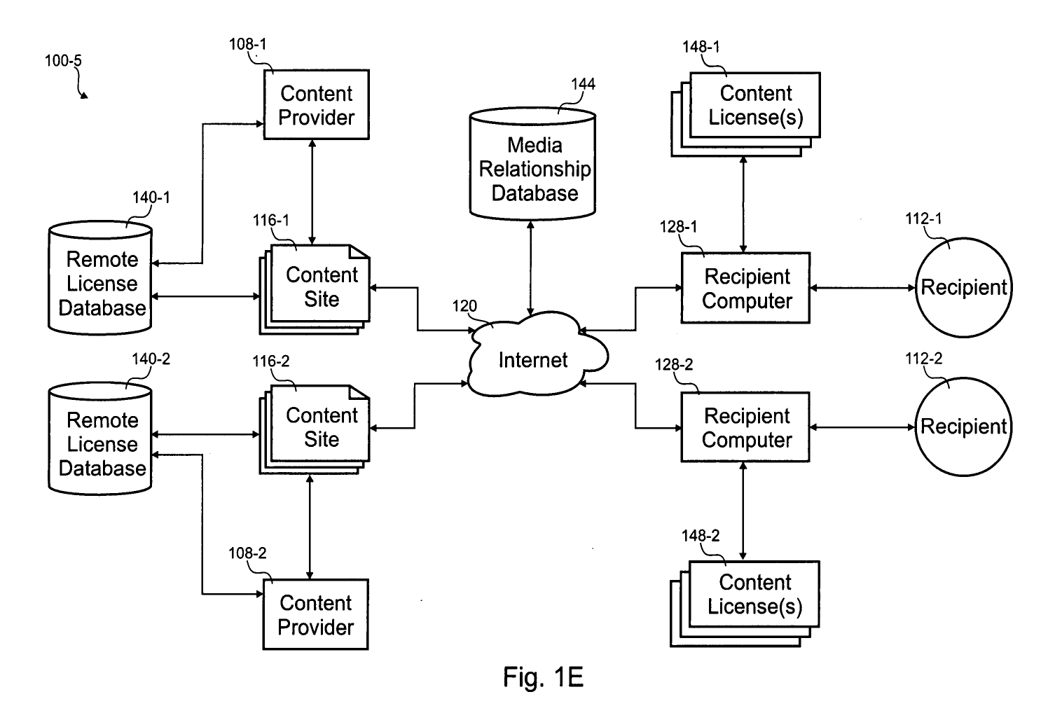

Referring initially to FIG. 1A, a block diagram of an embodiment of a content management system 100-1 is shown. This embodiment shows two content providers 108 and two recipients 112, but there could be any number of each in various embodiments. The content management system 100 could have different configurations with certain blocks spit or combined and/or spread among different locations to achieve the disclosed functionality.

A recipient 112 or licensee interacts with a recipient computer system 128 that is coupled to a content site 116 over the Internet 120 or some other wide area network. The content site 116 is a series of web pages, applets, forms, etc. that allow choosing, purchasing, checking status, and downloading of content and licenses. The recipient computer system 128 could include a music player, a video player, a personal video recorder (PVR), a personal digital assistant (PDA), a desktop computer, a laptop computer, or any other device or program that allows realizing content. Interaction with the content site 116 is performed with a web browser, embedded software and/or application software on the recipient computer 128. One or more programs downloaded from the content site 116 may aid in the interaction.

Coupled or integral to the recipient computer 128 is a local license database 136. The local license database 136 could be maintained by the operating system for all content programs or could be maintained by a content program. In some embodiments, there could be a number of local license databases 136 on a recipient computer 128. The license database 136 includes information on which media the recipient 112 or a group of recipients has a right to use. Each media is uniquely identified and tied in the database to one or more content licenses. The content licenses are copyright licenses that have various rights to the various forms of media, derivatives and related performances. All the purchased licenses and terms are stored in the local license database 136. Some embodiments may only store a token in the local license database 136. Each token would correspond to a license and/or terms that could be retrieved when an upgrade or further purchase of media is contemplated.

When a piece of media is purchased, several license terms are offered to the recipient 112. The below Table shows just some of the license options that might be offered to a prospective recipient 112. One or more web pages or screens could be presented at the content site would include all these options.

| Cost | License Term(s) |
|---|---|
| .50 | Right to download this media without upgrades |
| .05 | Right to trade this media for one another media at a later time |
| .10 | Right to trade this media for another media any number of times |
| .10 | Right to sell this media to one other recipient |
| .10 | Right to this performance on one other media that is selected now |
| | or at a later time |
| .10 | Right to this media with streaming rights to this performance |
| .20 | Right to this performance on any other available media during this |
| | transaction |
| .25 | Right to this performance on any other available media for the next |
| | year |
| .30 | Right to this performance and one other performance of the work |
| .35 | Right to this performance on any other available media for the life |
| | of the recipient |
| .40 | Right to this performance and any other performance of the work |
| .45 | Transferable right to sell a single copy of the media to another |
| | recipient |
| free | Right to share a small defined fraction of the media with 5 others |

There are many different variations of the content license that could be purchased from the example shown in the Table. Other embodiments could have more or less license terms to choose from. The basic license right to the media in the selected form is fifty cents, but other additional rights can be added. Some embodiments allow adding the additional rights at a later time, but the pricing could change. In one example that uses the Table, the recipient might pay sixty cents for the selected media (e.g., MP3 formatted file compressed to a 160 kbps bitrate) and the right for another media (e.g., losslessly compressed CD quality version) now or at another time. Various embodiments could bundle a selection of the rights in the table.

Another selection from the Table that is available for free in this embodiment is the right to send an excerpt of the media to five others, for example, to send one level of a game to five other game owners. A fifty level game could be sold with levels one through ten and five levels randomly selected from levels ten through fifty. The randomly selected levels could be sent to a number of friends (e.g., 5, 10, 20, etc.). A community associated with the game could facilitate the exchange of levels. Missing levels could be also purchased in groups or individually. One license term may allow all the missing levels between ten and fifty.

Another example of how someone might excerpt portions of the media is for videos or music. A recipient could send a music or video clip to a friend to expose them to a portion of the performance. The clip could be limited to a fraction of the original and could be at reduced quality. For example, the recipient could create a custom trailer for a movie that is sent to a friend. Some embodiments could charge or give credit for this license term. Another example might give the recipient the ability to take an excerpt from a book (e.g., a chapter, page, or group of pages) and send it to a friend or retain it after the book or eBook is sold.

License terms may give rights or discounts to related performances. A particular performance may be available in written, photographed, video taped, theatrical, and/or recorded form. The form may be available in various media and formats. When one form is purchased, the recipient may have a right to other forms if that term was purchased. For example, purchase of a movie may allow purchase of the soundtrack for a discount. In another example, purchase of a theatrical script in written form may entitle allow attending the play in theatrical form.

A concept reflected in some embodiments of the system 100 is that a recipient or group of recipients may not have to pay copyright holders multiple times for the same or related performance. If multiple purchases are made in one embodiment, the recipient gets a discount on the copyright license portion of the payment for a particular media. The costs associated with creating the media and delivering it to the recipient 112 are still generally paid, but the copyright is priced separately. For example, the copyright holder receives a payment when an 8 track tape is purchased, but might get a smaller or no copyright payment when the CD version is purchased by the same recipient. The discount may require destroying or returning the old media. In another example, a recipient may be able to exchange an entire collection of CDs for mini-disk versions of those same CDs at a discounted price.

In one embodiment, the recipient 112 is sold a license to stream or rent the content. The right to stream the content may be one time or recurring and have different pricing. These limited rights could also have optional license terms to related content and different forms of the content. For example, where a video is rented, the recipient may later choose to purchase the video at a discount.

A content provider 108 is associated with the content site 116. The content provider 108 provides the content and codes it onto media for the recipient 112. The content may be stored within the content provider 108 or requested according to recipient demand. Various copyright holders and their agents supply the content to the content provider 108. The ability for the content provider 108 to offer content in various tangible forms with various license terms is regulated by the copyright holders associated with each performance.

Various performances (e.g., a sound performance, a videotaped performance, a written performance, a pictured performance, a theatrical performance, etc.) are offered in a tangible form. There are many options for the tangible form that are defined by their media (e.g., disk, book, eBook, file, tape, film, record, music score, written play, poster, print, slide, etc.) and format (e.g., CD, DVD, HD DVD, laser disk, MD disk, hard bound book, soft bound book, pamphlet, brochure, audio or video files using various compression schemes and bitrates, cassette tape, 8 track tape, reel-to-reel tape, 35 mm film, 50 mm film, 8 mm film, vinyl record, wax record, etc.). A content provider 108 may support some or all of these tangible forms. In some cases, the tangible forms are created on the fly, for example, the user may select MP3 at a 320 Kbps bitrate that is generated from a master CD after request by a recipient 112.

This embodiment has a remote license database 140 that is accessible to the content provider. The remote license database 140 tracks the same sort of information for each recipient 112 as that stored in each local client database 136. Should a particular recipient 112 lose their local license database 136, it can be recreated with information from the remote license databases 140 for content providers 108 that provided content to the recipient 112.

For each requested piece of content, the available license terms, copyright license price and relationships are stored in a media relationship database 144. When a piece of content is requested, the various license variations are retrieved from the media relationship database 144 and presented to the recipient. Related performances are stored in the media relationship database 144 and available for presenting to the recipient during the initial purchase or at a later time if rights to related performances were purchased initially or at some later time.

Any number of relationships between performances might be stored in the media relationship database. This information could be presented to inform the recipient of the interrelationships or to give discounts for buying related material. Various embodiments could relate artist, label, director, producer, writer, etc.

With reference to FIG. 1B, a block diagram of another embodiment of the content management system 100-2 is shown. This embodiment does not maintain a local license database 136, but does maintain content licenses 148. Some content on the recipient computer 128 may not have express licenses. The content license 148 indicates for each piece of content how it can be used, shared, copied, stored, played, etc. Additional terms in the content license 148 may be used to get discounts on content related to that licensed. A DRM function in the recipient computer 128 may use the content license 148 to enforce the rules and terms.

The content licenses 148 could be embedded in a number of files (e.g., in a download manager file) or in the content files themselves. In any event, the content licenses 148 could be retrieved locally or from a remote license database 140. Where the content license 148 is stored locally, they may be presented to any content provider 108 for a discount on related content. In this embodiment, only the content provider 108 that originally sold the content and the local content licenses 148 store the content license information. Other embodiments could share content license information between the content providers 108.

Referring to FIG. 1C, a block diagram of yet another embodiment of the content management system 100-3 is shown. This embodiment has a media relationship database 144 accessible to all content providers 108. The stored relationships could be maintained by the content originators and copyright holders. Various promotions could be offered by modifying the terms and pricing in the media relationship database 144.

This embodiment also includes a global license database 152. As content licenses are purchased and recorded by the recipient system and the content provider system, the licenses are also recorded in a global license database 152. A content provider 108 may query the global license database 152 during the transaction for licenses of the particular recipient that may have been purchased from another content provider 108. Some embodiments may periodically synchronize their remote license database 140 with the global license database 152 such that checking the global license database 152 with each transaction is not performed.

With reference to FIG. 1D, a block diagram of one embodiment of the content management system 100-4 is shown. This embodiment does not include remote license databases 140 for each content provider 108. During the transaction the global license database 152 is queried for related content licenses and terms that might cover the recipient's current purchase. Any new licenses or terms purchased are reported back to the global license database 152 to keep it current.

Referring to FIG. 1E, a block diagram of still another embodiment of the content management system 100-5 is shown. This embodiment uses a media relationship database 144 accessible to content providers 108 that do not maintain their own. The pricing of the various copyright licenses and terms that are set by the copyright holders could be marked up or priced in different ways by the various content providers.

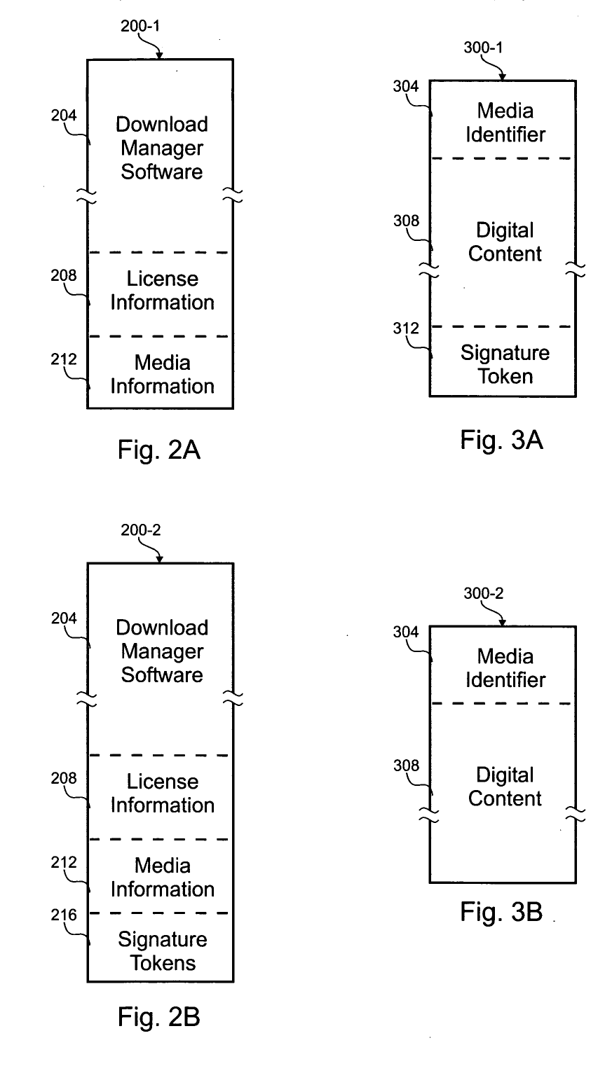

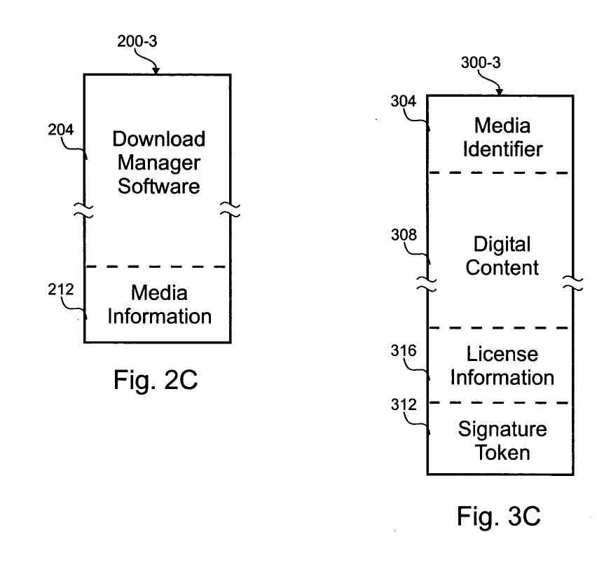

With reference to FIG. 2A, a data structure of an embodiment of a download manager file 200-1 is shown. When one or more pieces of content are purchased, a download manager file 200 is formulated to facilitate the download process. The download manage file 200 includes download manager software 204, license information 208 and media information 212. In some embodiments, the license information 208 and the media information 212 could be in XML format and may or may not be encrypted.

The download manager software 204 is executed by activating the download manager file 200. The download manager software 204 takes the license information 208 and populates the local license database 136 with the licenses and terms purchased. Using the media information 212, the download manager software 204 can request the referenced pieces of content from the content provider 108. The media information 212 includes a location of the digital media file, any media identifier and could include a mechanism to identify the recipient 112. A content creator 168, the content provider 108, a content delivery network or any other origin server could be specified in the media information 212.

After each piece of content is downloaded, it is authenticated. Should the digital media file not authenticate, another copy is requested. Upon successfully receiving the file, the content provider is notified. The download manager software 204 also informs the content provider of the server, drive, path and filename that was for the digital media file.

The download manager file 200 can be executed anytime to initiate download and population of the license database 136. Execution of the file 200 at a second time may allow downloading the referenced pieces of content again. Some embodiments may limit the number of times that content pieces can be downloaded or may define a time period after which further downloads are no longer allowed.

When the download manager file 200 is executed after prior download, the download manager file 200 and referenced digital media files are authenticated again. Where a file is changed, deleted, infected with a virus or otherwise corrupted, the file can be replaced by the download manager software 204. A recipient can repopulate and check their library of content by executing all the download manager files 200 on his or her computer 128. In some embodiments another program manages this process of maintaining authentic content.

Referring next to FIG. 2B, a data structure of another embodiment of the download manager file 200-2 is shown. This embodiment includes signature tokens 216 in the download manager file 200-2. Each digital media file that is downloaded has a signature token 216 that can be used to authenticate the digital media file. The signature token 216 could be a hash, checksum, CRC, or some other code that is generated over the digital media file.

In one embodiment, encryption is used to authenticate the digital media file. A key is provided that can be used to decrypt the digital media file. If the digital media file has been modified, the decrypted file will be scrambled. Private or public keying could be used. Each digital media file and download manager file could be encrypted to provide a level of authentication. Encryption could be used in addition to the signature token in some embodiments.

Referring next to FIG. 2C, a data structure of yet another embodiment of the download manager file 200-3 is shown. This embodiment only includes the download manager software 204 and media information 212. License information and signature tokens could be maintained by the content provider and/or in a global database accessible to the download manager software 204. Other embodiments could include the license information and signature tokens with the digital media file or download them separately.

With reference to FIG. 3A, a data structure of an embodiment of a digital media file 300-1 is shown. This embodiment of the digital media file 300-1 includes a media identifier 304, digital content 308 and a signature token 312. The media identifier 304 is a unique code that allows correlating the digital media file 300 to license information. Each recipient of a piece of content could have a unique code that is also stored in the media identifier 304 to allow correlation with a particular recipient 112. The digital content 308 is the payload that delivers the piece of content in whatever format it might take. The signature token 312 allows authenticating that the digital content 308 is unchanged.

After download and authentication, some embodiments separate the digital content 308 from some or all of the remaining portions of the digital media file 300. In some embodiments, portions of the removed portions are added into metadata supported by the digital content. For example, the media identifier 304 could be put in an ID3 tag of a MP3 file.

Referring next to FIG. 3B, a data structure of another embodiment of the digital media file 300-2 is shown. This embodiment does not include the signature token 312 with the digital media file 300. The token 312 could be included in the associated manager file 200, separately downloaded and/or available from a remote database. A database local to the recipient computer 128 could store the tokens 312 for later authentications.

With reference to FIG. 3C, a data structure of yet another embodiment of a digital media file 300-3 is shown. This embodiment includes the media identifier 304, the digital content 308, license information 316, and the signature token 312. The license information 316 indicates the copyright license and terms available for the digital content 308. After download, the license information could be loaded into a database local to the recipient computer 128 or otherwise store them.

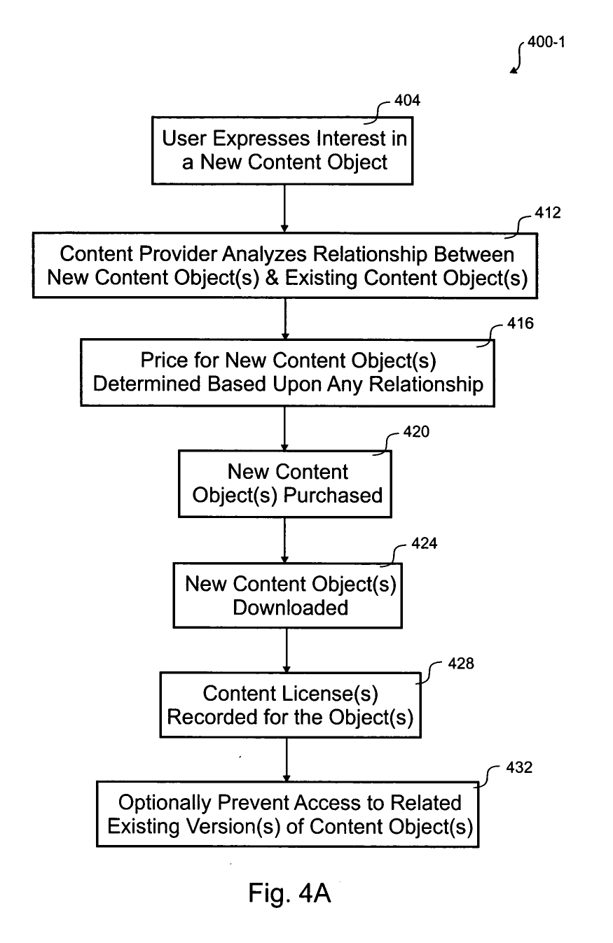

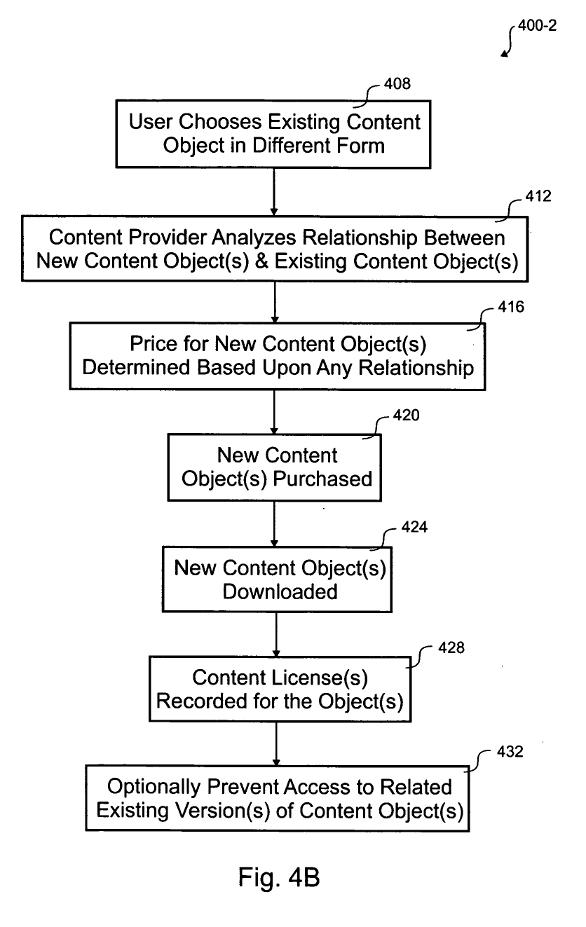

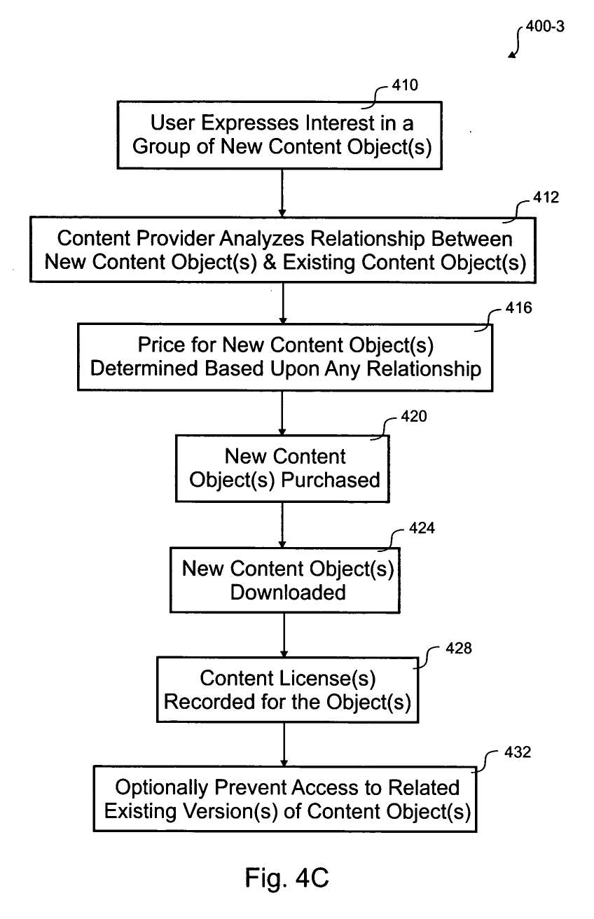

With reference to FIG. 4A, a flow diagram of an embodiment of a process 400-1 for ordering digital content is shown. The depicted portion of the process 400-1 begins in step 404 where the user has interacted with the content site 116 of a content provider 108 to express interest in a new content object in a particular form. In step 412, the content provider 108 determines the content object licenses and terms already purchased by the recipient by referencing any of the content licenses 148, the local license database 136, the remote license database 140, and the global license database 152 that are available to the content provider 108 that might have license or term information for the recipient 112. Where there are licenses and/or terms that allow discounts on related content the media relationship database 144 is referenced to find related content.

A price for the new content object is determined based upon any prior licenses or terms in step 416. There may be a number of additional license terms that may be optionally purchased and are displayed for the recipient. The recipient 112 may also be presented with the performance and related performances in various forms for purchase as a bundle in some embodiments. At any rate, the recipient 112 purchases the content object(s) in step 420. A download manager file 200 is formulated by the content provider 108 and downloaded to the recipient computer 128. Upon execution of the download manager software 204, the content object(s) is downloaded in step 424.

The content license(s) are recorded in step 428. Depending on the system 100 capability, recordation takes place in any combination of the content licenses 148, the local license database 136, the remote license database 140, and the global license database 152. Some licenses and terms require destroying of the related content object(s) that resulted in the discount. This makes the new content object(s) appear to be an exchange. In step 432, the related content object(s) is deleted or is otherwise prevented from future access. The license database(s) are updated accordingly to reflect the deletion.

Referring next to FIG. 4B, a flow diagram of another embodiment of a process 400-2 for ordering digital content is shown. In this process 400-2, the recipient 112 asks the content provider 108 for a piece of content in a different form in step 408. The recipient 112 can choose from the supported formats. Based upon the prior license, terms or upgrades thereto, the recipient 112 is offered the different form at a discount or not. The discount may be different if the existing content object is not relinquished. The remainder of the process 400-2 is the same as FIG. 4A.

With reference to FIG. 4C, a flow diagram of yet another embodiment of a process 400-3 for ordering digital content is shown. In this embodiment, the recipient 112 expresses interest in a group of content objects in step 410. For example, the user might want all music associated with a particular performance or artist. Another example could be where a user wants to upgrade their library of content or a portion thereof to a different format (e.g., from a 320 Kbps bit rate to a 128 Kbps bit rate). The remainder of the steps is the same as FIG. 4A except that they are performed for the whole group. The recipient 112 may be given an additional group discount for converting or upgrading a number of content objects at one time.

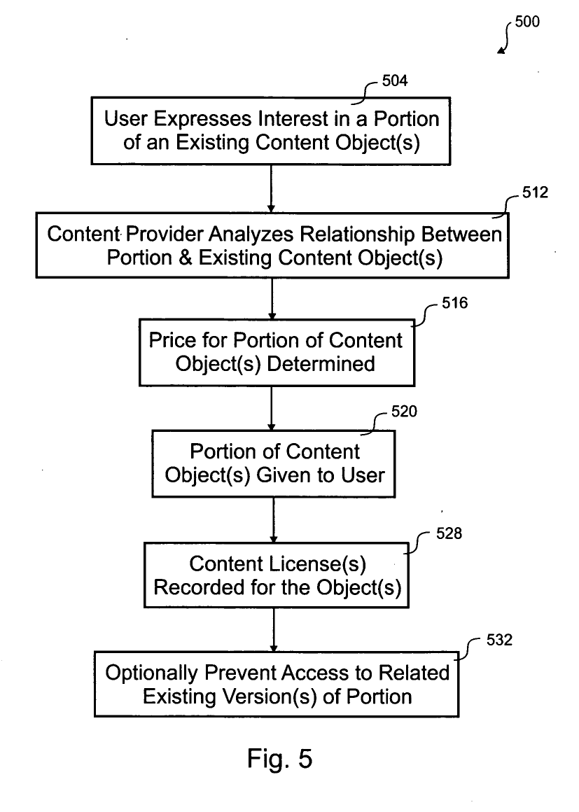

Referring next to FIG. 5, a flow diagram of an embodiment of a process 500 for licensing a digital content portion is shown. In this embodiment, the recipient has a license term that allows use of a subset of some content piece and perhaps create a derivative work. The depicted portion of the process begins in step 504 where the user expresses interest in a portion of a derivative of an existing content object in the recipient's library. The licenses or terms and the indicated modification are analyzed in step 512. A price is determined in step 516 and the license rights and terms are formulated for the new digital media file 300. In some cases this right may have been included in the original license of the content object such that additional payment is unnecessary.

In step 520, the portion or derivative is given to the user. This may involve DRM commands to allow the modification. The content license and terms for the portion or derivative are recorded in step 528. In some cases, the prior version of the content object may be destroyed as part of the license given on the portion or derivative in step 532.

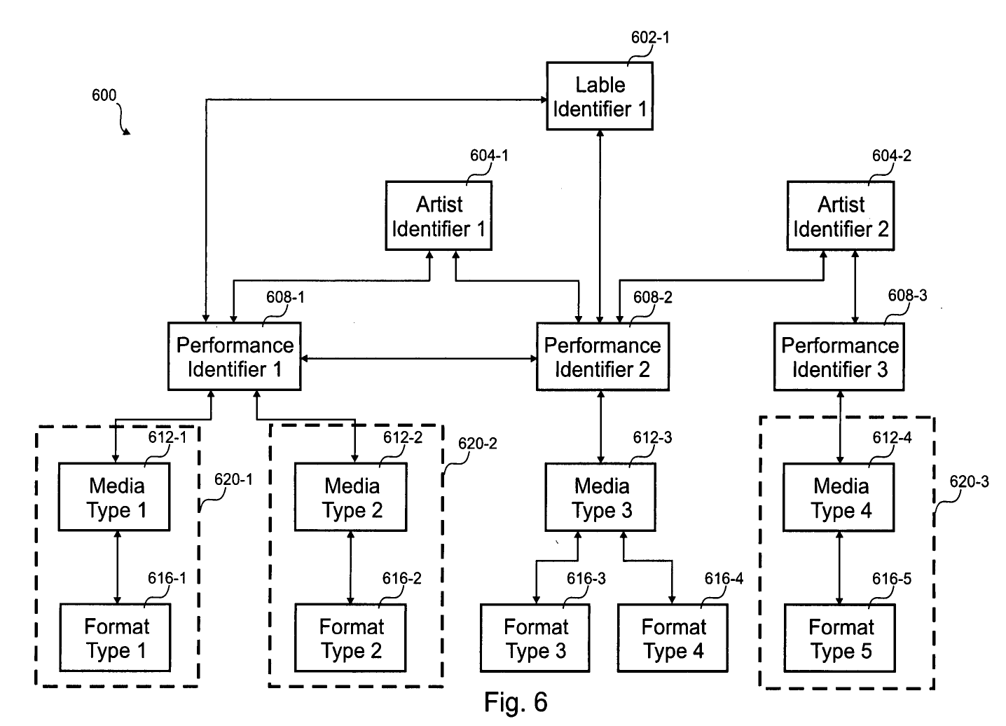

With reference to FIG. 6, a chart of an embodiment of media relationships 600 for a small portion of a content catalog is shown. This chart shows related performances 608 and artists 604 and labels 602 who own copyrights in those performances. Also shown in the chart are the forms 620 that the piece of content can be purchased (i.e., the media and format types 612, 616 that can be purchased). Each of the artists, labels and performances has an identifier associated with it that is stored in the media relationship database 144.

In the example depicted in the present chart, several relationships can be discerned. The same information could be discerned from the media relationship database 144 with the content provider 108 is determining how to price a related piece of content. In this example, a first and second performances 608-1, 608-2 are related. For example, one might be the studio performed version of a song and the other a live performance. Both performances 608-1, 608-2 are associated with a first artist 604-1 and a first label 602-1. The second performance 608-2 is also associated with a second artist 604-2. The first performance 608-1 is available in two forms 620-1, 620-2. The first form 620-1 has a first media type 612-1 and a first format 616-1 (e.g., file media type in a MP3, 160 Kbps, format type).

While the principles of the invention have been described above in connection with specific apparatuses and methods, it is to be clearly understood that this description is made only by way of example and not as limitation on the scope of the invention.

1. A method for management of pieces of content and content licenses, the method comprising steps of:
selling a content license for a first piece of content to a user;
storing the content license;
providing the first piece of content in a first form;
analyzing the content license;
determining an offer for a second piece of content in a second form, wherein the offer is affected by the content license; and
selling the second piece of content to the user according to the offer, wherein:
the first form is different from the second form,
wherein the second piece is sold in a second transaction different from a first transaction where the first piece is sold, and
at least one of the first piece and the second piece is in digital form.

2. The method for management of pieces of content and content licenses of claim 1, wherein the first form varies from the second form by at least one of an encapsulating media type, a bitrate, and a compression format.

3. The method for management of pieces of content and content licenses of claim 1, wherein at least one of the first and second pieces of content include: video content, audio content, music content, still picture content, theatrical content, live performance content, aroma content, art content, printed text content, e-book content, video game content, and audio book content.

4. The method for management of pieces of content and content licenses of claim 1, wherein the content license expires after a period of time.

5. The method for management of pieces of content and content licenses of claim 1, wherein the first form differs from the second form in that the second form is a subset of the first form.

6. The method for management of pieces of content and content licenses of claim 1, wherein the first form is a complete work and the second form is a portion of the complete work.

7. The method for management of pieces of content and content licenses of claim 1, wherein the offer has a price of zero.

8. The method for management of pieces of content and content licenses of claim 1, wherein the offer includes costs of media and delivery, but does not require a purchase of a full copyright license.

9. The method for management of pieces of content and content licenses of claim 1, wherein:
the first form is a multi-level game and the second form includes a level of the multi-level game, and
the content license allows sharing the level with another person.

10. The method for management of pieces of content and content licenses of claim 1, implying the license after verifying possession of a media storing the first piece of content.

11. The method for management of pieces of content and content licenses of claim 1, disabling access to the first piece of content.

12. The method for management of pieces of content and content licenses of claim 1, wherein the offer comprises a price for the second piece of content.

13. The method for management of pieces of content and content licenses of claim 1, wherein the offer comprises a modification to the content license.

14. A computer-readable medium having computer-executable instructions for performing the computer-implementable method for management of pieces of content and content licenses of claim 1.

15. A computer system adapted to perform the computer-implementable method for management of pieces of content and content licenses of claim 1.

16. A method for acquiring licensed content, the method comprising steps of:
purchasing a copyright license to first artistic expression encapsulated in a first media in a first transaction;
receiving the first media;
initiating a second transaction for second artistic expression encapsulated in a second media, wherein:
the second artistic expression is addressed in the copyright license,
the second artistic expression is discounted in some way due to the copyright license,
the first media differs from the second media in at least one of: a media type, a bitrate, and a compression format; and
receiving the second media, wherein at least one of the first and second media use digital encoding to represent artistic expression.

17. The method for acquiring licensed content as recited in claim 16, wherein the receiving steps include receiving the first and second media from a content site.

18. The method for acquiring licensed content as recited in claim 16, wherein the receiving steps include receiving the first and second media from a plurality of content sites.

19. The method for acquiring licensed content as recited in claim 16, further comprising a step of storing the content license on equipment of a licensee.

20. The method for acquiring licensed content as recited in claim 16, further comprising a step of storing the content license remote to a location of a licensee.

21. A computer-readable medium having computer-executable instructions for performing the computer-implementable method for acquiring licensed content of claim 16.

22. A computer system adapted to perform the computer-implementable method for acquiring licensed content of claim 16.

23. A method for management of pieces of content and content licenses, the method comprising steps of:
selling a content license associated with the first piece of content to a user;
storing the content license;
providing a first piece of content encapsulated in a first media;
receiving a request for a second piece of content encapsulated in a second media;
determining if the content license applies to the second piece of content;
determining an offer for the second piece of content, wherein the offer is affected by the content license; and
sending the second piece of content to the user according to the offer, wherein:
the first media is different from the second media, and
wherein the second piece is sold in a second transaction different from a first transaction where the first piece is sold.

24. The method for management of pieces of content and content licenses of claim 23, wherein at least one of the first piece and the second piece is in digital form.

25. The method for management of pieces of content and content licenses of claim 23, wherein the first media varies from the second media by at least one of an encapsulating media type, a bitrate, and a compression format.

26. The method for management of pieces of content and content licenses of claim 23, wherein a group of media are requested in bulk and each of the group is put the steps of claim 23.

27. The method for management of pieces of content and content licenses of claim 23, wherein the second media was unavailable at the time of the first transaction.

28. A computer-readable medium having computer-executable instructions for performing the computer-implementable method for management of pieces of content and content licenses of claim 23.

29. A computer system adapted to perform the computer-implementable method for management of pieces of content and content licenses of claim 23.
